(19) United States
(12) Patent Application Publication
(10) Pub. No.: US 2006/0176625 A1
(43) Pub. Date: Aug. 10, 2006

(54) Circuit protection devices having an integral barrier with grounding provision

(76) Inventor: Mark S. Shander, Mill Creek, WA (US)

Correspondence Address: LEE & HAYES, PLLC, 421 W. RIVERSIDE AVE., SUITE 500, SPOKANE, WA, 99201, US

(21) Appl. No.: 11/052,505

(22) Filed: Feb. 4, 2005

(51) Int. Cl. H02H 3/00

(52) U.S. Cl. 361/42

(57) ABSTRACT

A circuit protection apparatus having an integral grounding provision is disclosed. In one embodiment, the apparatus includes a circuit breaker having an integral over-current circuit that is responsive to a selected transient current condition. At least one conductive contact is positioned on an external portion of the circuit breaker that is coupled to the circuit. A barrier is positioned on the external portion of the breaker and configured to electrically couple to the at least one conductive contact to a selected electrical potential.

### FIELD OF THE INVENTION

This invention relates generally to electrical systems and, more specifically, to circuit protection devices used in electrical systems.

### BACKGROUND OF THE INVENTION

Circuit protection devices are commonly used to protect various circuits in an electrical system from damage due to excessive currents that stem from an overload condition, such as a short circuit condition within a circuit, or other similar electrical fault conditions within the system. Typically, the circuit protection device includes a bimetallic element that is responsive to a persistent over-current condition in a protected circuit. The bimetallic element is subjected to Joule heating during an over-current condition and deforms to unlatch a spring-loaded operating mechanism coupled to the bimetallic element, which in turn, opens separable electrical contacts within the device to interrupt current to the protected circuit.

The foregoing circuit protection device generally provides sufficient circuit protection where the fault condition is persistent in the protected circuit. During a sporadic fault condition, however, such as an intermittent electrical arc in the protected circuit, the overload protection capability of the circuit protection device may not operate, since a root-mean-square (RMS) value of the fault current is generally insufficient to heat bimetallic element, so that the spring-loaded mechanism fails to unlatch.

Accordingly, arc-fault circuit interrupters are available that include an electronics package having a microprocessor operable to detect the sporadic fault condition, and further operable to control one or more power transistors that interrupt current to the protected circuit when the sporadic fault is detected. The electronics package within the arc-fault circuit interrupters must be coupled to a source of electrical energy in order to perform its intended function. The electronics package is typically powered by coupling the package to a voltage potential, such as a line and/or a load terminal on the circuit interrupter, and to a ground potential. Accordingly, in one known arc-fault circuit interrupter, a separate electrical lead is provided that is configured to be coupled to the ground potential. The addition of the separate electrical lead generally adds to the overall weight of the interrupter, and disadvantageously contributes to the number of conductors associated with the interrupter.

In another known arc-fault circuit interrupter, an electrical socket is provided that is configured to receive an electrical pin that is coupled to a ground conductor. Although this approach decreases the weight of the interrupter, the electrical pin may inadvertently become decoupled from the electrical socket, thus defeating the arc-fault protection afforded by the electronics package. In still another known interrupter, an engineered surface bond is employed to provide a ground connection between the interrupter and a structural portion that supports the interrupter, such as an electrical panel or a mounting bracket. The engineered surface bond typically comprises a conductive terminal or faying surface that abuts the structural portion so that a ground path is established.

Although an engineered surface bond to a structural portion eliminates the need for an additional ground conductor, drawbacks nevertheless exist. For example, in one conceivable failure mode, undesired conduction paths may be established between the interrupter and other similar interrupters and/or electrical components that may render the electronics package within the interrupter inoperative. Further, and in another potential failure mode, hazardous voltage levels may be introduced to the structural portion, constituting a significant electrical shock hazard to personnel. In still another possible failure mode, a bonding strap employed to couple the structural portion to another structural member or even a ground bus may at least partially fail, so that the low impedance path to ground provided by the strap is partially, or even completely compromised.

Consequently, there is a distinct need for a circuit protection device that provides a reliable ground to a structural portion, while saving weight.

### SUMMARY

Circuit protection apparatus having an integral grounding provision are disclosed. In one aspect, an apparatus includes a circuit breaker having an integral over-current circuit that is responsive to a selected transient current condition. At least one conductive contact is positioned on an external portion of the circuit breaker that is coupled to the circuit. A barrier is positioned on the external portion of the breaker and configured to electrically couple to the at least one conductive contact to a selected electrical potential.

### BRIEF DESCRIPTION OF THE DRAWINGS

The disclosed embodiments of the present invention are described in detail below with reference to the following drawings.

FIG. 1 is an exploded isometric view of a circuit protection device according to an embodiment of the invention;

FIG. 2 is a partial cross sectional view of the barrier viewed along the axis 2-2 of FIG. 1;

FIG. 3 is an exploded isometric view of a circuit protection device according to another embodiment of the invention;

FIG. 4 is a partial cross sectional view of the flexible portion viewed along an axis 4-4 of FIG. 3;

FIG. 5 is a side elevation and partial cross-sectional view of the circuit protection device of FIG. 3; and

FIG. 6 is a side elevation view of an aircraft having one or more of the disclosed embodiments of the present invention.

### DETAILED DESCRIPTION

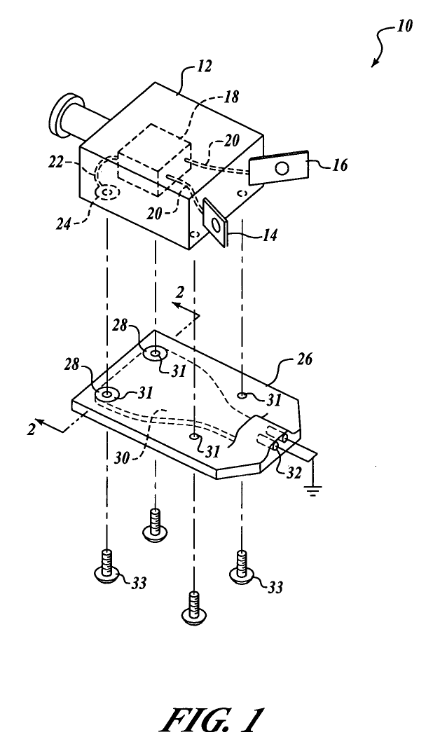

The present invention relates to circuit protection devices, and more particularly, to circuit protection devices having barriers that include an integral grounding provision. Many specific details of certain embodiments of the invention are set forth in the following description and in FIGS. 1 through 6 to provide a thorough understanding of such embodiments. One skilled in the art, however, will understand that the present invention may have additional embodiments, or that the present invention may be practiced without one or more of the details described in the following description.

FIG. 1 is an exploded isometric view of a circuit protection device 10 according to an embodiment of the invention. The circuit protection device 10 includes an arc-fault circuit breaker 12 that is operable to protect a selected circuit. The circuit breaker 12 accordingly includes a line terminal 14 that is coupled to a source of electrical power, and a load terminal 16 that is coupled to the selected circuit. The arc-fault circuit breaker 12 also includes an electronics package 18 operable to interrupt a current between the line terminal 14 and the load terminal 16 upon the detection of a sporadic electrical fault, such as an electrical arc, or other intermittent electrical faults. Suitable arc-fault circuit breakers 12 include the ARC-ALERT circuit protection device, available from the Eaton Corporation of Cleveland, Ohio, and the KLIXON ARC SHIELD circuit protection device, available from Texas Instruments, Incorporated of Dallas Tex., although other suitable alternatives exist. The electronics package 14 includes internal electrical leads 20 that are coupled to a selected one, or even both the line terminal 14 and the load terminal 16, and also at least one internal ground lead 22 that is coupled to one or more conductive contact pads 24 positioned on an exterior portion of the breaker 12. Although FIG. 1 generally depicts a circuit protection device configured to be coupled to a single-phase circuit, it is understood that the foregoing embodiment may also include, without limitation, a circuit breaker that is configured to be coupled to a multi-phase circuit.

The circuit protection device 10 also includes a barrier 26 that is configured to be removably coupled to the breaker 12 so that the conductive contact pads 24 contact corresponding conductive contact pads 28 positioned on the barrier 26 when the barrier 26 is coupled to the breaker 12. The barrier 26 may also include one or more apertures 31 that project through selected portions of the barrier 26 so that fasteners 33 may be received in corresponding threaded holes in the breaker 12 to mechanically affix the breaker 12 to the barrier 26. The barrier 26 generally includes a non-conductive, relatively rigid polymeric material, such as a thermosetting or a thermoplastic polymer. In one particular embodiment, the barrier 26 may be comprised of the G-10/FR-4 thermosetting industrial laminate, which provides a continuous filament glass cloth material embedded within an epoxy resin binder. A conductive element 30 is embedded within the barrier 26 that electrically couples the at least one conductive terminal 32 to the conductive contact pads 28. Accordingly, the electronics package 18 within the breaker 12 may be coupled to a ground potential through the conductive terminal 32. The provision of more than a single conductive terminal 32 on the barrier 26 advantageously permits ground connections on an assembly comprised of a plurality of the circuit protection devices 10 to be serially coupled, or “daisy-chained”.

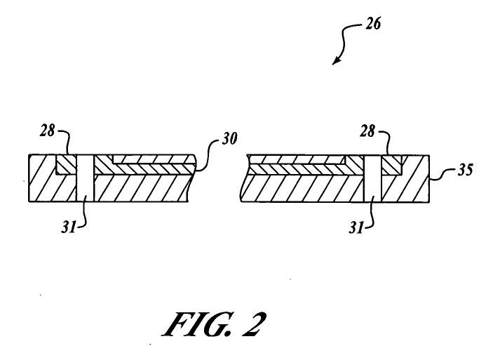

FIG. 2 is a partial cross sectional view of the barrier 26 viewed along the axis 2-2 of FIG. 1, which will be used to describe the foregoing embodiment in greater detail. The conductive element 30 is embedded within a dielectric substrate 35 so that the conductive element 30 is substantially insulated from conductive contact with other external structures. Accordingly, electrical contact with the conductive element 30 is achievable solely through the conductive pads 28 and the one or more conductive terminals 32 (FIG. 1). Although the conductive element 30 is shown in FIG. 2 as a planar conductive element, other configurations are possible. For example, the conductive element 30 may be comprised of one or more conductors having a circular cross section (e.g., wires embedded in the dielectric substrate). Although the barrier 26 shown in FIG. 2 is coupleable to the breaker 12 (FIG. 1) using the fasteners 33 (also shown in FIG. 1), it is understood that the breaker 12 may be coupled to the barrier 26 by other means. For example, in one particular embodiment, the one or more conductive pads 28 may be adhesively bonded to corresponding conductive surfaces on the breaker 12 using an electrically conductive epoxy resin, such as the TIGA 901 Room Temperature Curing Silver Conductive Epoxy, available from Resin Technology Group, LLC of South Easton, Mass.

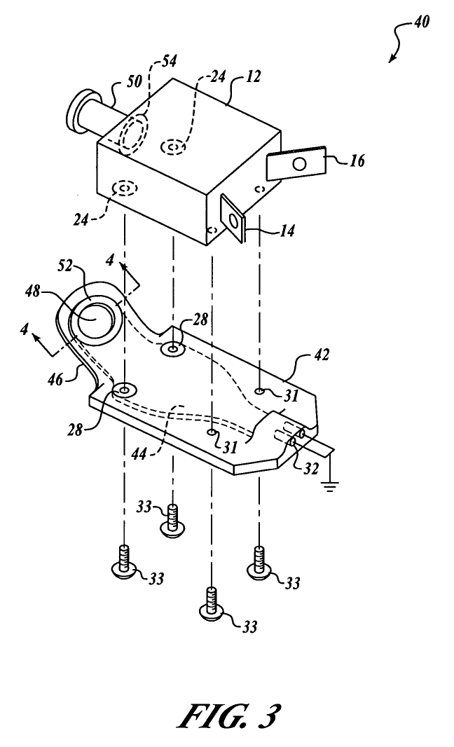

FIG. 3 is an exploded isometric view of a circuit protection device 40 according to another embodiment of the invention. Many of the features of the present embodiment have been described in detail in connection with other embodiments, and in the interest of brevity, will not be described further. The circuit protection device 40 includes the arc-fault circuit breaker 12 that was described above in connection with FIG. 1. The circuit protection device 40 also includes a barrier 42 that is configured to be removably coupled to the breaker 12. The barrier 42 includes a flexible portion 46 that is hingeably coupled to the barrier 42, which further includes an aperture 48 that is suitably sized to accommodate a stem portion 50 of the breaker 12. A conductive element 44 is embedded in the barrier 42 that electrically couples the conductive terminal 32 to the conductive pads 28 and also to a conductive pad 52 proximate to the aperture 48. The conductive pad 52 is configured to electrically couple to a corresponding contact surface 54 on the breaker 12, and also to couple the barrier 42 to a panel or other structural portion (not shown) that supports the circuit protection device 40.

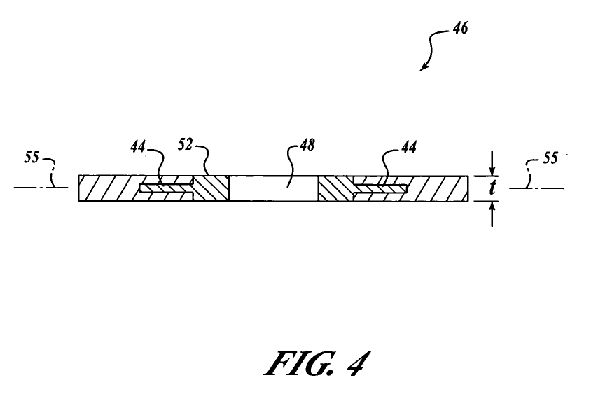

FIG. 4 is a partial cross sectional view of the flexible portion 46 viewed along the axis 4-4 of FIG. 3, which will be used to describe the foregoing embodiment in greater detail. The flexible portion 46 has a section thickness t that may be generally less than a corresponding thickness of the barrier 46, so that the flexible portion 46 may be flexurally deformed about a neutral axis 55 that extends through the flexible portion 46. Additionally, the section thickness t is sufficiently small that it does not adversely impact the mounting of the device 40 in a mounting panel, as will be discussed in further detail below. The conductive pad 52 also extends through the flexible portion 46 and extends outwardly from the aperture 48 so that the conductive element 44 may form a low impedance electrical coupling with the contact surface 54 on the breaker 12 (FIG. 3) and also to a corresponding contact location on the mounting panel, or other structural portion supporting the protection device 40. Although the flexible portion 46 is shown in FIG. 3 and FIG. 4 as a generally planar member that extends outwardly to a conductive pad 52 that is configured to electrically couple to contact surfaces on the breaker 12 and the panel (not shown), other configurations are possible. For example, in a particular embodiment, one or more wires, conductive braids, or other similar conductive members may be coupled to the conductive element 44 at one end and extend outwardly from the barrier 42. A second end may then include a conductive collar that is suitably sized to accommodate the stem portion 50 of the breaker 12.

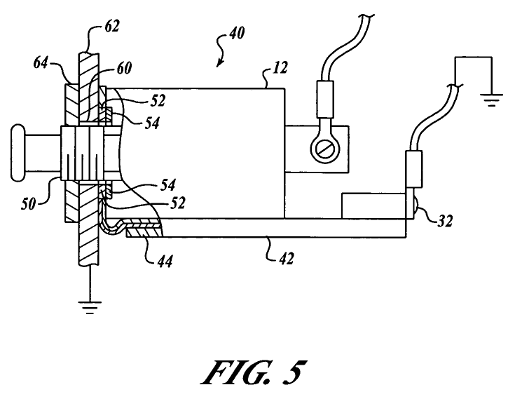

FIG. 5 is a side elevation and partial cross-sectional view of the circuit protection device 40, which will be used to further describe the present embodiment. The circuit protection device 40 may be received into an opening 60 formed into a panel 62. The stem portion 50 of the breaker 12 is generally configured to threadably engage a locking collar 64 that fixably retains the device 40 in the panel 62. The conductive pad 52 of the flexible portion 46 is interposed between the panel 62 and the contact surface 54 on the breaker 12, and provides a low impedance electrical path to ground potential for the device 40. Since the flexible portion 46 is relatively thin, an engagement length of the stem portion 50 is not adversely impacted. Although FIG. 5 shows the conductive terminal 32 coupled to ground, it is understood that, in other embodiments, the conductive terminal 32 may be omitted, so that the device 40 is electrically coupled to the ground potential through the panel 62 only. Alternately, the terminal 32 may advantageously supplement the grounding of the device 40 by providing a redundant path to ground.

In another particular embodiment of the invention, the foregoing barriers 26 and 42 as shown in FIG. 1 and FIG. 3, respectively, may comprise a portion of a retrofit kit. Electrical circuits in many applications are currently protected by conventional bimetallic circuit breakers that are responsive to a relatively constant over-current condition, as discussed in detail above. In many of these applications, it may be desirable to substitute an arc-fault circuit breaker for the bimetallic circuit breaker, in order to further protect the electrical circuits against damage due to transient over-current conditions. Accordingly, the disclosed barriers 26 and 42 may be used to install the arc-fault circuit breaker in electrical equipment that is presently configured for a conventional bimetallic circuit breaker.

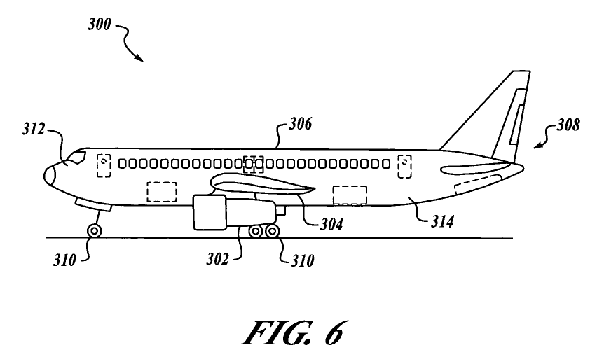

Those skilled in the art will also readily recognize that the foregoing embodiments may be incorporated into a wide variety of different systems. Referring now in particular to FIG. 6, a side elevation view of an aircraft 300 having one or more of the disclosed embodiments of the present invention is shown. With the exception of the embodiments according to the present invention, the aircraft 300 includes components and subsystems generally known in the pertinent art, and in the interest of brevity, will not be described in detail. The aircraft 300 generally includes one or more propulsion units 302 that are coupled to wing assemblies 304, or alternately, to a fuselage 306 or even other portions of the aircraft 300. Additionally, the aircraft 300 also includes a tail assembly 308 and a landing assembly 310 coupled to the fuselage 306. The aircraft 300 further includes other systems and subsystems generally required for the proper operation of the aircraft 300. For example, the aircraft 300 includes a flight control system 312 (not shown in FIG. 6), as well as a plurality of other electrical, mechanical and electromechanical systems that cooperatively perform a variety of tasks necessary for the operation of the aircraft 300. Accordingly, the aircraft 300 is generally representative of a commercial passenger aircraft, which may include, for example, the 737, 747, 757, 767 and 777 commercial passenger aircraft available from The Boeing Company of Chicago, Ill.

Although the aircraft 300 shown in FIG. 6 generally shows a commercial passenger aircraft, it is understood that the various embodiments of the present invention may also be incorporated into flight vehicles of other types. Examples of such flight vehicles may include manned or even unmanned military aircraft, rotary wing aircraft, or even ballistic flight vehicles, as illustrated more fully in various descriptive volumes, such as Jane's All The World's Aircraft, available from Jane's Information Group, Ltd. of Coulsdon, Surrey, UK.

With reference still to FIG. 6, the aircraft 300 may include one or more of the embodiments of the circuit protection device 314 according to the present invention, which may operate in association with the various systems and sub-systems of the aircraft 300. Although the foregoing embodiments of the invention relate specifically to aircraft systems, it is understood that circuit protection devices are nevertheless present in other types of vehicles, including various forms of terrestrial vehicles such as ground and marine vehicles, which may utilize the various embodiments of the present invention without significant modification. Furthermore, it is understood that the various embodiments of the present invention may also be employed in stationary power generation systems, or even in domestic or commercial building electrical systems.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A circuit protection apparatus, comprising:
a circuit breaker having an integral over-current circuit responsive to a selected transient current condition and having at least one conductive contact positioned on an external portion of the circuit breaker that is coupled to the circuit; and
a barrier positioned on the external portion and configured to electrically couple to the at least one conductive contact to a selected electrical potential.

2. The circuit protection apparatus of claim 1, wherein the over-current circuit is responsive to an arc-fault condition.

3. The circuit protection apparatus of claim 1, wherein the barrier further comprises at least one conductive contact positioned to electrically couple to the at least one conductive contact positioned on the external portion of the breaker.

4. The circuit protection apparatus of claim 3, wherein the barrier further comprises a dielectric substrate having a conductive element embedded in the dielectric substrate and coupled to the at least one electrical contact on the barrier.

5. The circuit protection apparatus of claim 4, wherein the conductive element is further coupled to at least one conductive terminal configured to couple to the selected electrical potential.

6. The circuit protection apparatus of claim 4, wherein the substrate further comprises a flexible portion in electrical communication with the conductive element and extending outwardly from the substrate, the flexible portion being configured to conductively engage a selected portion of the breaker.

7. The circuit protection apparatus of claim 6, wherein the flexible portion is configured to engage a stem portion of the circuit breaker.

8. A barrier configured to be removably engaged with a circuit interruption device, comprising:
a planar dielectric substrate having a conductive element embedded in the substrate;
a first electrical contact coupled to the conductive element and configured to electrically communicate with a corresponding electrical contact positioned on the circuit interruption device; and
a second electrical contact spaced apart from the first electrical contact that is configured to electrically communicate with a selected electrical potential.

9. The barrier of claim 8, wherein the second electrical contact is configured to electrically communicate with a ground potential.

10. The barrier of claim 8, wherein the second electrical contact further comprises an aperture that projects through the substrate and through the second electrical contact that is suitably dimensioned to permit a fastener to pass through the substrate and engage a selected fastener portion of the circuit interruption device.

11. The barrier of claim 8, further comprising a flexible portion that extends outwardly from the substrate, and further wherein the second electrical contact is positioned on the flexible portion.

12. The barrier of claim 11, wherein the second electrical contact is configured to engage a stem portion of the circuit protection device.

13. A retrofit kit that permits a first circuit protection device to be replaced with a second circuit protection device in an electrical circuit, comprising:
a planar dielectric substrate having a conductive element embedded in the substrate;
a first electrical contact coupled to the conductive element and configured to electrically communicate with a corresponding electrical contact positioned on the second circuit protection device; and
a second electrical contact spaced apart from the first electrical contact that is configured to electrically communicate with a selected electrical potential.

14. The retrofit kit of claim 13, wherein the second circuit protection device comprises an arc-fault circuit protection device

15. The retrofit kit of claim 13, wherein the second electrical contact is configured to electrically communicate with a ground potential.

16. The barrier of claim 13, wherein the second electrical contact further comprises an aperture that projects through the substrate and through the second electrical contact that is suitably dimensioned to permit a fastener to pass through the substrate and engage a selected fastener portion of the circuit interruption device.

17. The barrier of claim 13, further comprising a flexible portion that extends outwardly from the substrate, and further wherein the second electrical contact is positioned on the flexible portion.

18. The barrier of claim 16, wherein the second electrical contact is configured to engage at least one of a stem portion of the circuit protection device, and a surface of an electrical panel to be retrofitted.

19. An aerospace vehicle, comprising:
a fuselage;
wing assemblies and an empennage operatively coupled to the fuselage;
at least one propulsion unit coupled to one of the fuselage and the wing assemblies;
a source of electrical energy coupled to at least one of the propulsion unit and the fuselage;
at least one electrical circuit that couples the source to a selected electrical load positioned in one or more of the fuselage, wing assemblies, empennage and propulsion unit; and
an electrical circuit protection device coupled to the at least one circuit and interposed between the source and the load, further comprising:
a circuit breaker having an integral over-current circuit responsive to a selected transient current condition and having at least one first conductive contact positioned on an external portion of the circuit breaker; and
a barrier positioned on the external portion of the breaker, the barrier including a planar dielectric substrate having a conductive element embedded in the substrate that electrically communicates with at least one second conductive contact that abuts the first conductive contact, the conductive element operable to couple the at least one second conductive contact to a selected electrical potential.

20. The aerospace vehicle of claim 19, wherein the barrier further comprises a flexible portion that extends outwardly from the substrate and includes the second conductive contact.
